(19) United States
(12) Patent Application Publication
(10) Pub. No.: US 2026/0350311 A1
(43) Pub. Date: Nov. 5, 2026

(54) DOCUMENT EXTRACTION AND PROCESSING SYSTEMS AND METHODS

(71) Applicant: DLA PIPER LLP (US), BALTIMORE, MD (US)

(72) Inventors: Eric FALKENBERRY, New York, NY (US); Noah GIOIOSA, Boston, MA (US); Ye CHEN, New York, NY (US); Daniel CHAN, New York, NY (US)

(73) Assignee: DLA PIPER LLP (US), BALTIMORE, MD (US)

(21) Appl. No.: 19/647,136

(22) Filed: Apr. 14, 2026

Related U.S. Application Data
(60) Provisional application No. 63/797,573, filed on Apr. 30, 2025.

(51) Int. Cl. G06F 40/279; G06F 40/226

(52) U.S. Cl. CPC G06F 40/279; G06F 40/226

(57) ABSTRACT

Systems and methods described herein can automatically generate a plurality of extraction templates, wherein each respective extraction template of the plurality of extraction templates corresponds to a separate respective document type of the plurality of document types, and automatically validate each of the plurality of extraction templates, the validating comprising determining that one or more fields are correctly filled in response to performing an extraction on a document of the respective document type corresponding to the respective extraction template. Documents can be classified as belonging to document types, and at least one processor can extract data from the document according to the applicable extraction templates and validate the data according to the applicable validation templates.

### CROSS-REFERENCE TO RELATED APPLICATIONS

This application claims priority to U.S. Provisional Application No. 63/797,573 filed Apr. 30, 2025, which is incorporated by reference in its entirety.

### BACKGROUND

Many systems take in data from documents for storage and use in other processes. Sometimes, the documents are highly standardized, making data extraction and classification relatively straightforward. However, deviations from such standardization can occur for a variety of reasons and make processing much more difficult. In some cases, documents are not standardized at all, or use multiple standards. In any event, data extraction from documents is rarely straightforward.

### BRIEF DESCRIPTIONS OF THE DRAWINGS

FIG. 1 shows an example document extraction and processing system according to some embodiments of the disclosure.

FIG. 2 shows an example document extraction and processing process according to some embodiments of the disclosure.

FIGS. 3A-3B show an example extraction template development process to some embodiments of the disclosure.

FIG. 4 shows an example validation template development process according to some embodiments of the disclosure.

FIG. 5 shows an example preprocessing process according to some embodiments of the disclosure.

FIG. 6 shows an example extraction process according to some embodiments of the disclosure.

FIG. 7 shows an example validation, review, and publication process according to some embodiments of the disclosure.

FIG. 8 shows an example computing device according to some embodiments of the disclosure.

### DETAILED DESCRIPTION OF SEVERAL EMBODIMENTS

Systems and methods described herein can improve document processing in a computing environment. For example, systems and methods described herein can provide automatic, customized template creation for a wide range of documents and use cases. Templates may be specific to different document types, improving data extraction overall and for specific documents. Systems and methods described herein can use the templates to automatically extract data of interest from documents even when variations in document quality, format, content, etc. present technical challenges for data extraction. Systems and methods described herein can also incorporate customized and flexible validation techniques enabling validation of entire documents and/or collections of documents, as opposed to sampling-based validation. This can improve extraction accuracy and/or reduce downstream workload considerably.

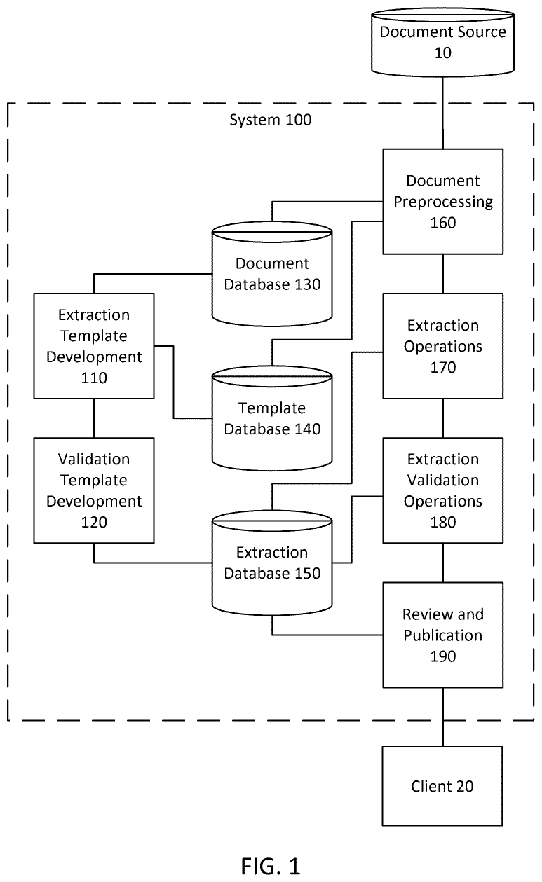

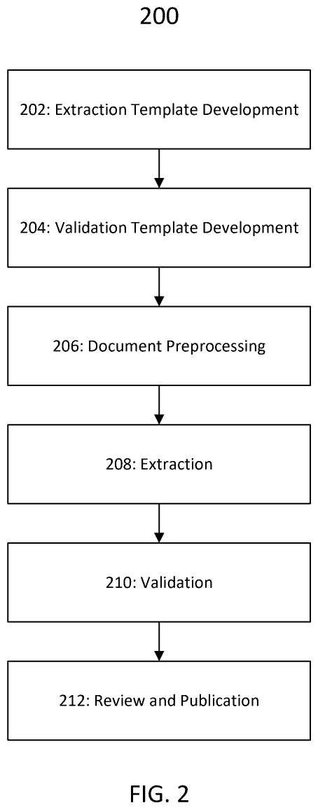

FIG. 1 shows an example document extraction and processing system 100 according to some embodiments of the disclosure. System 100 may include one or more modules, such as extraction template development module 110, validation template development module 120, document preprocessing module 160, extraction operations module 170, extraction validation operations module 180, and/or review and publication module 190. System 100 may include one or more databases or other data stores, such as document database 130, template database 140, and/or extraction database 150. System 100 may be in communication with one or more document sources 10 and/or clients 20. The elements of system 100 are described in greater detail below with respect to FIGS. 2-7, but in general, system 100 can develop templates for document extraction and/or validation and use the templates to perform document extraction and/or validation.

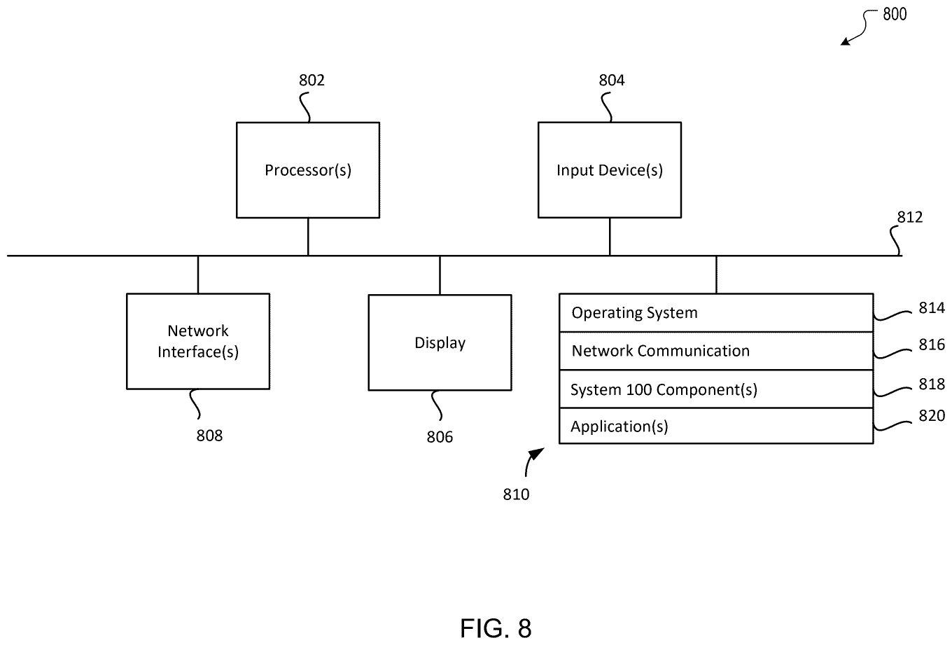

Illustrated components may include a variety of hardware, firmware, and/or software components that may interact with one another. Some components shown in FIG. 1 may communicate with one another using networks. For example, system 100 may communicate with document source 10 and/or client 20 through one or more networks (e.g., the Internet, an intranet, and/or one or more networks that provide a cloud environment). In some embodiments, elements of system 100 may communicate with one another through the one or more networks. Each component may be implemented by one or more computers (e.g., as described below with respect to FIG. 8).

Elements illustrated in FIG. 1 (e.g., system 100 (including extraction template development module 110, validation template development module 120, document database 130, template database 140, extraction database 150, document preprocessing module 160, extraction operations module 170, extraction validation operations module 180, and/or review and publication module 190), document source 10, and client 20) are each depicted as single blocks for ease of illustration, but those of ordinary skill in the art will appreciate that these may be embodied in different forms for different implementations. For example, while separate modules of system 100 are depicted separately, any combination of these elements may be part of a combined hardware, firmware, and/or software element. Moreover, while the modules are depicted as parts of a single system 100 element, any combination of these elements may be distributed among multiple logical and/or physical locations. Also, while one document source 10, one client 20, one system 100, one extraction template development module 110, one validation template development module 120, one document database 130, one template database 140, one extraction database 150, one document preprocessing module 160, one extraction operations module 170, one extraction validation operations module 180, and one review and publication module 190, this is for clarity only, and multiples of any of the above elements may be present. In practice, there may be single instances or multiples of any of the illustrated elements, and/or these elements may be combined or co-located.

In the following descriptions of how the illustrated components function, several examples are presented. However, those of ordinary skill in the art will appreciate that these examples are merely for illustration, and the disclosed embodiments are extendable to other application and data contexts.

FIG. 2 shows an example document extraction and processing process 200 according to some embodiments of the disclosure. Process 200 is an example of processing that system 100 may perform from end to end. For example, process 200 includes template development and subsequent use of such templates within document processing, extraction, and/or publication. Accordingly, system 100 may perform all or part of process 200, and/or may perform various parts of process 200 in various sequences and/or concurrently, in various embodiments.

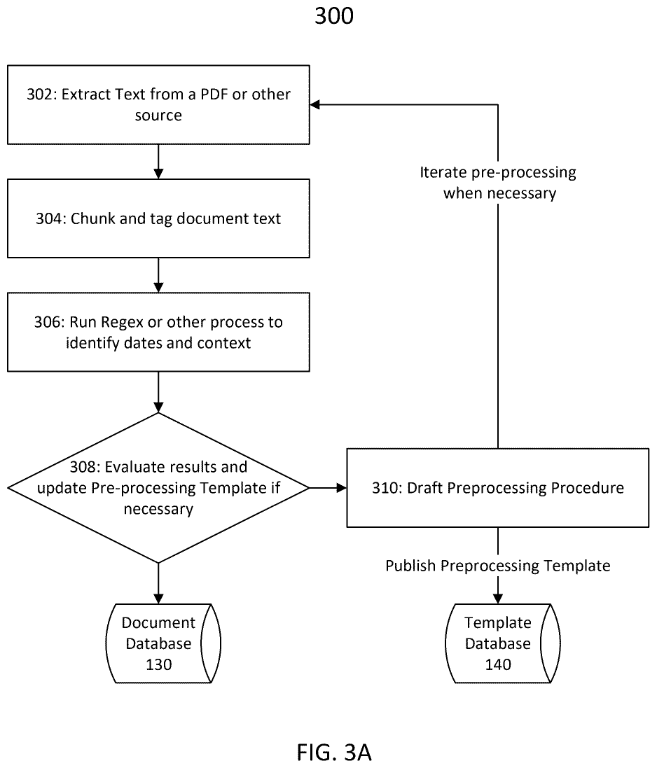

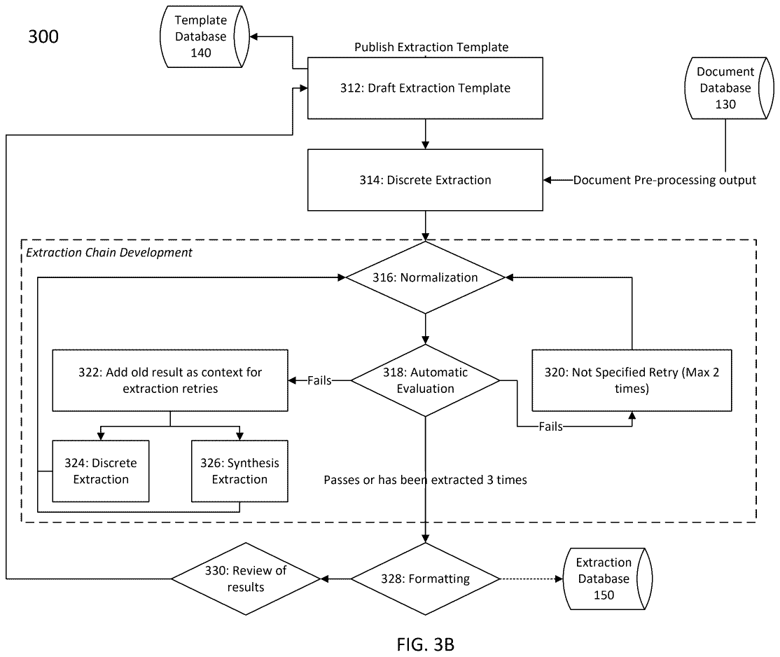

At 202, system 100 can perform extraction template development. For example, extraction development template module 110 can use curated documents and preprocessing procedures to create extraction templates that system 100 may use to process real documents. FIGS. 3A-3B, described in detail below, present an example extraction template development process 300 that may be performed at 202.

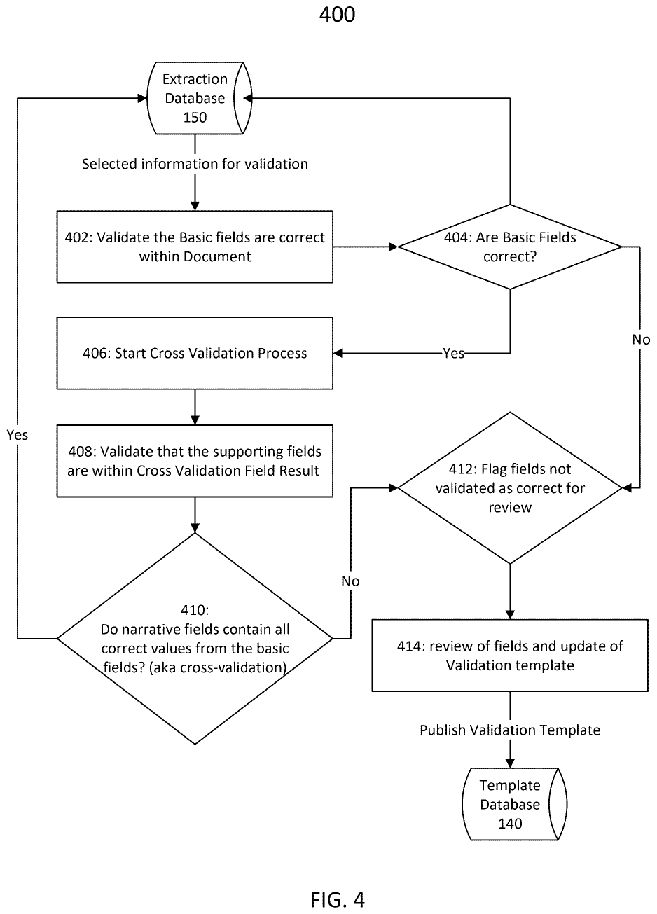

At 204, system 100 can perform validation template development. For example, validation development template module 120 can use some or all of an extraction template as generated at 202 and/or curated documents and preprocessing procedures to create validation templates that system 100 may use to process real documents. FIG. 4, described in detail below, presents an example validation template development process 400 that may be performed at 204.

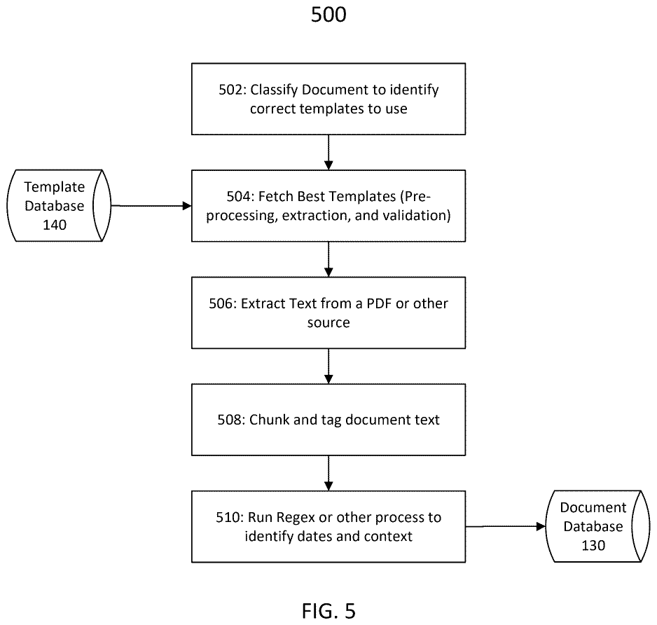

At 206, system 100 can perform document preprocessing. For example, preprocessing module 160 can receive production documents to be processed and use templates developed at 202 and 204 to prepare such documents for extraction processing. FIG. 5, described in detail below, presents an example preprocessing process 500 that may be performed at 206.

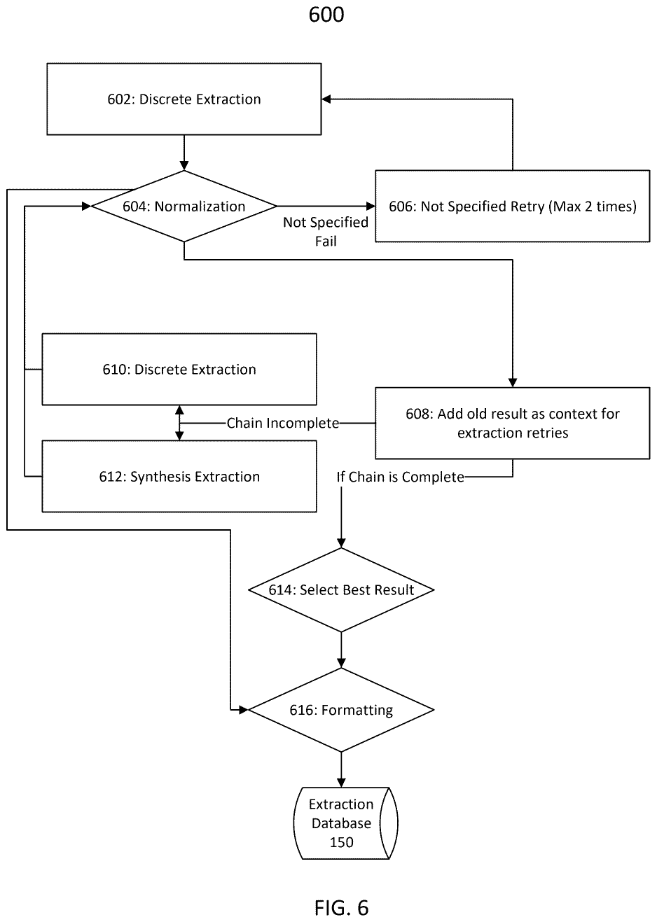

At 208, system 100 can perform extraction. For example, extraction operations module 170 can receive preprocessed production documents from preprocessing module 160 and extract data from the preprocessed production documents. FIG. 6, described in detail below, presents an example extraction process 600 that may be performed at 208.

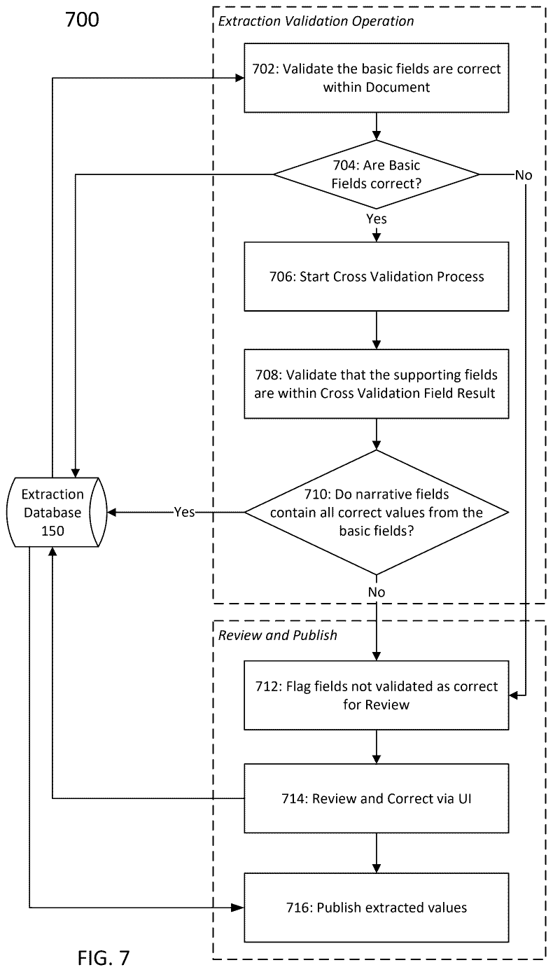

At 210, system 100 can perform validation. For example, extraction validation operations module 180 can validate the extracted data obtained at 208. FIG. 7, described in detail below, presents an example validation, review, and publication process 700 that may be performed, at least in part, at 210.

At 212, system 100 can perform review and publication. To the extent it is determined that review is required at 210, for example, review and publication module 190 can facilitate review of the extracted data obtained at 208. FIG. 7, described in detail below, presents an example validation, review, and publication process 700 that may be performed, at least in part, at 212.

FIGS. 3A-3B show an example extraction template development process 300 to some embodiments of the disclosure. By performing process 300, system 100 can generate an extraction template that can be used to define data to be extracted from documents processed by system 100, for example.

Templates may include a collection of metadata, prompts, and inputs for the processing of each type of document. Templates may be tailored to the document type and may provide the input and instructions for the extraction and validation of the desired fields. Templates may include the field names, field types, extraction descriptions, extraction types, output examples, output formats, selection options, special types, ‘Not Specified’ flags, simple validation prompts, and cross validation prompts. By generating templates, system 100 can tailor the subsequent data extraction process to a given document type.

At 302, extraction development template module 110 can extract text from a document, such as a PDF, or other source. For example, extraction development template module 110 can extract text according to one or more pre-processing settings. In some embodiments, documents can be ingested for extraction through a pipeline between document source 10 and system 100. The pipeline may be used during template development and, as described below, during production, in some embodiments. During development, documents and ground truth may be received at this stage. Extraction may include extracting text using optical character recognition (OCR) and/or other known and/or novel text extraction techniques.

At 304, extraction development template module 110 can chunk and tag document text. For example, extraction development template module 110 can chunk and tag document text according to one or more pre-processing settings.

At 306, extraction development template module 110 can run regex or perform other processing to identify dates and context or other target information. For example, extraction development template module 110 can identify dates and context or other target information according to one or more pre-processing settings.

At 308, extraction development template module 110 can evaluate results and update a pre-processing template if necessary. Pre-processing settings may be chosen based on document type for extracting machine-readable text from the document, tagging and chunking that text for context retrieval purposes, and/or application of natural language processing to dates, as noted above. In an initial iteration, extraction development template module 110 may use a first set of pre-processing settings. Pre-processing settings may be established through testing to ensure applicability to data received from document source 10 in some embodiments. For example, when confronted with a new document type, extraction development template module 110 can test various settings in order to optimize performance.

At 310, extraction development template module 110 can prepare a draft preprocessing procedure. The results of this Pre-Processing (“Pre-Processing Output”) may be ingested by one or more large language models (LLMs) as part of the template development process. LLMs may evaluate the results of extracting at 302, chunking and tagging at 304, and/or regex at 306. Any LLM may be used. In some embodiments, a small LLM (e.g., GPT 4o mini) may be used for pre-processing because it may be adequate for handling isolated and/or one dimensional pre-processing tasks without the latency and/or token cost of a larger or more state of the art LLM (e.g., GPT 4o). If the resulting draft preprocessing procedure is lacking in performance according to the evaluation, processing at 302-308 may be repeated until a desired (e.g., predefined) level of performance is reached, resulting in final settings. The final settings may be stored along with the template in the template database 140.

At 312, extraction development template module 110 can prepare a draft extraction template. Templates may include a collection of metadata, prompts, and/or inputs for the processing of each type of document. The templates may provide the input and instructions for the extraction and validation of the desired fields. Extraction development template module 110 can prepare a separate draft extraction template for each of a number of respective document types, and the example process described herein illustrates creation of one such draft extraction template. By creating separate templates for separate document types, system 100 can significantly improve extraction quality and completeness when extraction is performed on real documents. Extraction development template module 110 can store each template in template database 140, and during development, an existing template which is most applicable to the new document type may be chosen from the template database 140 as described below.

After a document of a new type, for which no template is already available in template database 140, is preprocessed at 310, extraction development template module 110 can generate a new draft template assigned to the new document type. For example, a template may include field names, field types, extraction descriptions, extraction types, extraction prompts, output examples, output formats, selection options, special types, ‘Not Specified’ flags, simple validation prompts, cross validation prompts, other options, and/or combinations thereof. Draft templates may be generated automatically and/or may be created and/or edited by users in accordance with a fields analysis to be more closely tailored to a new document type.

At 314, extraction development template module 110 can perform discrete extraction. Discrete extraction generally refers to the process of extracting data that can be extracted verbatim from the document (e.g., a particular date). In some embodiments, extraction development template module 110 may prompt an LLM with a prompt including the template and instructions to extract structured data from the Pre-Processing Output as generated at 310. At this stage, only the portions of the new template related to extraction may be passed through an LLM along with the Pre-Processing Output, rather than the entire template, which may reduce bandwidth, latency, and/or token use. Any LLM may be used, but in some embodiments, a large and/or state of the art LLM (e.g., GPT 4o) may be chosen to provide high performance in the relatively complex extraction tasks of process 300.

The following is a specific, non-limiting example of a prompt that may be used to cause the LLM to perform extraction. It should be understood that variations to the prompt may be possible, as long as the chosen prompt causes extraction:
<SYSTEM>

You are a top-tier algorithm for extracting information from text.

Only extract information that is relevant to the provided text.

If no information is relevant, use the schema and output an empty list where appropriate.

{extraction_template_instructions}

Here is the JSON Schema I'll validate your output against:

```
‘‘‘json
{
  ″title″: ″extractor″,
  ″description″: ″Extract information matching the given schema.″,
  ″type″: ″object″,
  ″properties″: {
    ″name″: {
      ″type″: ″string″,
      ″description″: ″The full name of the person″,
      ″examples″: [
        ″Jane Doe″
      ]
    },
    ″email″: {
      ″type″: ″string″,
      ″format″: ″email″,
      ″description″: ″The email address of the person″,
      ″examples″: [
        jane.doe@example.com
      ]
    },
    ″dob″: {
      ″type″: ″string″,
      ″format″: ″date″,
      ″description″: ″The person's date of birth (YYYY-MM-DD)″,
      ″examples″: [
        ″1985-07-24″
      ]
    }
  },
  ″required″: [
    ″name″,
    ″email″,
    ″dob″
  ]
}
</SYSTEM>
<USER>
I need to extract information from the following text:
{text}
For additional context, the following is a previous extraction that either
contains extra information, not enough information, or is incorrect:
{previous extraction}
Ensure that the current extraction corrects the previous extraction.
</USER>
```

I need to extract information from the following text:
{text}

For additional context, the following is a previous extraction that either contains extra information, not enough information, or is incorrect:
{previous extraction}

Ensure that the current extraction corrects the previous extraction.
</USER>

The following is a specific, non-limiting example of a prompt that may be used to cause the LLM to perform extraction consolidation. It should be understood that variations to the prompt may be possible, as long as the chosen prompt causes extraction consolidation:
FIELD NAME:
{field_name}
FIELD DESCRIPTION:
{description}

Below is a list of extractions which we want to use to generate a final extraction.

To generate the final extraction, either select one of the extractions exactly, or use a blend of all of them.

The final extraction should be the best version of the extractions that maintains the most information and aligns to the content.

Reply in json format with the key being the FIELD NAME and the value being your final extraction version.
{extractions}

The following is a specific, non-limiting example of a prompt that may be used to cause the LLM to perform tagging. It should be understood that variations to the prompt may be possible, as long as the chosen prompt causes tagging:
<SYSTEM>

You are a metadata labeler responsible for tagging document chunks. Note that in the document, any data value will always follow its corresponding label.

Compare the provided document chunk to each field name and description in the list. Consider all relevant information in the field descriptions to identify the appropriate field names.

Some fields require context related to other fields as well, be sure to tag the chunk with any field name that could be useful when making those decisions.

If the chunk is relevant to the name or description of a field, or if it contains related concepts or synonyms, list that field name in the output.

If no fields are relevant, reply with ‘None’. Use the exact wording of the field names in the output. Here is the JSON Schema I'll validate your output against:

```
‘‘‘json
{
  ″title″: ″meta_tagger″,
  ″description″: ″A tagger to label document chunks to reduce the context
  size for field extractions.″,
  ″type″: ″object″,
  ″properties″: {
    ″Related Field List″: {
      ″type″: ″array″,
      ″uniqueItems″: true,
      ″items″: {
        ″type″: ″string″,
        ″enum″: [/* your list of allowed field names—for example: * /
″First Name″, ″Last Name″, ″Date of Birth″, ″Address″, ″Phone
Number″]
      },
      ″description″: ″A list of field names relevant to the document
chunk. Reply with a list containing only ′None′ if no fields are relevant.″
    }
  },
  ″required″: [″Related Field List″]
}
</SYSTEM>
<HUMAN>
DOCUMENT CHUNK {chunk_number} out of {num_of_chunks}:
{chunk}
</HUMAN>
```

The following is a specific, non-limiting example of a prompt that may be used to cause the LLM to perform date finding. It should be understood that variations to the prompt may be possible, as long as the chosen prompt causes date finding:
<SYSTEM>

You are a metadata labeler responsible for tagging document chunks.

Scan the document chunk and identify any explicit dates or years present. A date must be clearly indicated by surrounding context or labels such as “Year”, “Month”, or “Date”.

The document may include partial date information split across multiple lines—for example, a year and a month may appear separately. In these cases:
Combine labeled values into a complete date formatted as YYYY-MM-DD.
If only a year and month are available, default to the first day of that month.
If only a year is available, default to January 1st of that year.
If a year appears partially (e.g., split into separate digits or with formatting issues), attempt to =reconstruct it based on labeled context. For instance, “Year 6” and “201” may indicate 2016.
If multiple months are listed for the same event, extract both as separate date entries if the context supports it.

Do not infer or generate dates from vague terms like “present”, “currently”, “ongoing”, or from seasons or general times of year.

Your goal is to extract dates that are explicitly present, even if fragmented across the text, and to capture the context that makes them identifiable.

Here is the JSON Schema I'll validate your output against:

```
‘‘‘json
{
  ″title″: ″date_finder″,
  ″description″: ″Extracts explicit dates and their supporting context from
  document chunks.″,
  ″type″: ″object″,
  ″properties″: {
    ″Dates″: {
      ″type″: ″array″,
      ″description″: ″A list of explicit dates extracted from the
document, each with its supporting context.″,
      ″items″: {
        ″type″: ″object″,
        ″properties″: {
          ″date″: {
            ″type″: ″string″,
            ″format″: ″date″,
            ″description″: ″A full date, month and year, or just a year.
If the year and month are provided on separate lines with labels,
combine them into a valid date formatted as YYYY-MM-DD. For
partial dates, default to the first day of the month or year.
For date ranges, do your best to figure out the correct start
and end date from all the context.″
          },
          ″context″: {
            ″type″: ″string″,
              ″description″: ″A description of the extracted date and
the supporting context from the document.″
          }
        },
        ″required″: [″date″, ″context″]
      }
    }
  },
  ″required″: [″Dates″]
}
</SYSTEM>
<HUMAN>
DOCUMENT CHUNK {chunk_number} out of {num_of_chunks}:
{chunk}
</HUMAN>
‘‘‘
```

At 316, extraction development template module 110 can perform normalization. For example, for fields which utilize a dictionary list, extraction development template module 110 can match the output to the list in order to normalize it to the desired form. In addition, all blank and not specified outputs may be normalized to “Not specified” or another placeholder. For fields that are normalized, formatting issues may be addressed automatically through the normalization. Extraction development template module 110 can validate structured fields for format, and invalidated formats may be automatically corrected later, as described below.

At 318, extraction development template module 110 can perform automatic evaluation, for example determining whether extraction should be retried or is complete. If automatic evaluation passes, for example because all fields have been extracted, processing may proceed at 328 as described below. If automatic evaluation fails, at 320, extraction development template module 110 can perform a retry. Alternatively or additionally, if automatic evaluation fails, at 322, extraction development template module 110 can add old result(s) as context for extraction retries.

The ground truth for the extractions may be introduced at this point so system 100 can automatically compare extractions to the ground truth during development. For example, based on development and testing data, certain fields may be prompted again when the extracted value is in misalignment with the ground truth according to calculated metrics (e.g., exact match, fuzzy match, extra info, etc.). In some embodiments, a maximum of two retries are attempted (other embodiments may retry a different number of times if at all), and if ‘Not specified’ continues to be returned, then the output may remain ‘Not specified.’ For fields for data that is almost always present in the given document, the LLM may be prompted to repeat the extraction when the returned output is ‘Not specified.’ This function can also be utilized with fields that almost always return the same value (e.g., 90%+ of complaints in a particular litigation are filed in “state” court, so a repeat could be utilized when the field value is ‘federal’ court).

In cases where extraction is to be retried, at 324, extraction development template module 110 can perform discrete extraction and/or, at 326, extraction development template module 110 can perform synthesis extraction. For example, extraction development template module 110 can prompt the LLM with an extracted value and instructions to repeat extractions, and these repeats can be Discrete or Synthesized (see below). Extraction development template module 110 may determine an optimal chain of events for extracting each field by comparing it to the ground truth. Field values can be the product of a single Discrete extraction, two Discrete extractions or a Discrete extraction followed by a Synthesized extraction, or other combinations, for example.

In discrete extraction at 324, extraction development template module 110 can prompt an LLM with the portion of the Template for a field, the output from the original Discrete extraction for that field, and the Pre-Processing Output. This discrete extraction may be similar to that performed at 314, except that the prompt may include the output from the original Discrete Extraction.

In synthesized extraction at 326, extraction development template module 110 can prompt the LLM to process an initial pass on the document and use the field description to select relevant portions of the Pre-Processing Output as context for a synthesized extraction. The LLM may also be prompted to provide some explanation as to why it selected or didn't select parts of the Pre-Processing Output as context for the extraction. Extraction development template module 110 can send the selected portions of the Pre-Processing Output and explanations to the LLM in a second prompt along with the portion of the Template for that field, and the output from the original Discrete Extraction. These extractions may be performed on every available field for synthesis at once. Synthesized extractions are generally those that may require the LLM to synthesize two or more pieces of data in the document in order to provide the desired extraction output (e.g., a collection of facts in a narrative). The synthesis prompt may include the portion of the Template for that field, the output from the original Discrete extraction, and the retrieved context.

The following is a specific, non-limiting example of a prompt that may be used to cause the LLM to perform context determination. It should be understood that variations to the prompt may be possible, as long as the chosen prompt causes context determination:
<USER>
{self.content}

Review the above document chunks and retrieve the entire paragraphs containing any information relevant to the following topics (with their descriptions):
{fields and definitions}
   The paragraphs should be copied verbatim (no paraphrasing).
   Organize your output by topic, listing each paragraph under its relevant heading.
</USER>

The following is a specific, non-limiting example of a prompt that may be used to cause the LLM to perform context explanation. It should be understood that variations to the prompt may be possible, as long as the chosen prompt causes context explanation:
<USER>
{self.content}

Review the above document chunks and retrieve the entire paragraphs containing any information relevant to the following topics (with their descriptions):
{fields and definitions}

For the information you decide to retrieve, provide an assessment or analysis explaining why the context is kept and how it supports the topics described.
</USER>

If automatic evaluation passes or extraction has been performed a maximum number of times, at 328, extraction development template module 110 can perform formatting. For structured fields, extraction development template module 110 can prompt the LLM with a structure to populate that may contain the field name, field type, and a description that specifies the desired format. This context may be passed to the LLM along with the extracted values and a prompt instructing the LLM to correct any formatting errors. The formatted result from the LLM may be used as the final output. Unstructured fields, such as those requiring narratives, may not go through this process.

The following is a specific, non-limiting example of a prompt that may be used to cause the LLM to perform formatting. It should be understood that variations to the prompt may be possible, as long as the chosen prompt causes formatting:
<SYSTEM>

You are a top-tier algorithm for extracting information from text.

Only extract information that is relevant to the provided text.

If no information is relevant, use the schema and output an empty list where appropriate.
{extraction_template_instructions}

Here is the JSON Schema I'll validate your output against:

```
‘‘‘json
{
  ″title″: ″extractor″
  ″description″: ″Extract information matching the given schema.″,
  ″type″: ″object″,
  ″properties″: {
    ″name″: {
      ″type″: ″string″,
      ″description″: ″The full name of the person″,
      ″examples″: [
        ″Jane Doe″
      ]
    },
    ″email″: {
      ″type″: ″string″,
      ″format″: ″email″,
      ″description″: ″The email address of the person″,
      ″examples″: [
        jane.doe@example.com
      ]
    },
    ″dob″: {
      ″type″: ″string″,
      ″format″: ″date″,
      ″description″: ″The person's date of birth (YYYY-MM-DD)″,
      ″examples″: [
        ″1985-07-24″
      ]
    }
  },
  ″required″: [
    ″name″,
    ″email″,
    ″dob″
  ]
}
</SYSTEM>
<USER>
I need to extract information from the following text:
{text}
For additional context, the following is a previous extraction that either
contains extra information, not enough information, or is incorrect:
{previous extraction}
Ensure that the current extraction corrects the previous extraction.
</USER>
```

At 330, extraction development template module 110 can review results. For example, extraction development template module 110 can display the final output alongside the ground truth on a platform (e.g., a Template Development Platform) which may automatically score the output using various metrics (exact match, fuzzy match, extra info, and LLM evaluation). A user can evaluate the final output, correct scoring errors, and/or make comments on each field. These inputs can assist the data scientist in editing the Template for a new run. After the Template is changed, the entire extraction process 300 may be repeated until the desired performance scores are achieved. Each run's extractions, ground truth, scoring, and extraction portions of the Template may be stored in the extraction database 150 for validation development. Once the desired performance scores are achieved, validation development may begin.

FIG. 4 shows an example validation template development process 400 according to some embodiments of the disclosure. By performing process 400, system 100 can generate a validation template that can be used to validate data extracted from documents processed by system 100, for example.

At 402, validation development template module 120 can validate that basic fields are correct within a document. Validation development template module 120 can pass portions of the template related to validation through the LLM along with the extracted values and the Pre-Processing Output. With respect to non-narrative fields, validation development template module 120 can prompt a smaller LLM with the field description, Pre-Processing Output, the extracted output, and a validation rubric designed to confirm that output. While any LLM may be used, some embodiments may use a smaller LLM (e.g., GPT 4o mini) for validation in process 400 as the validation tasks may be less complex than extraction, and the smaller LLM may be more efficient to operate. At 404, validation development template module 120 can determine whether basic fields are correct based on the simple validation.

The following is a specific, non-limiting example of a prompt that may be used to cause the LLM to perform field validation. It should be understood that variations to the prompt may be possible, as long as the chosen prompt causes field validation:
<SYSTEM>

Use the following information to reason through the extraction validation:
FIELD NAME: {field_name}
Field Description: {description}

If the extraction contains name misspellings, suffix differences, or capitalization differences, count it as correct.
DOCUMENT INFO:
{document}
VALIDATION PROCESS:

If no value is specified in the document or the document is empty, compare the extraction to the default value in the field description or “Not specified”.

Your task here is to explore the document based on the description and explain whether the extraction is accurate or not, including any reasoning behind your decision.

Formatting differences and variations in level of detail between the extraction and document info are acceptable.
</SYSTEM>
<USER>

### Explanation

Based on the document and field description, reflect on whether the extraction is correct. Consider all relevant details in the document and field description, and explain your reasoning.

Use a structured approach and explain why the extraction is correct or incorrect.

### Extraction

{extraction}
</USER>

If basic fields are correct, at 406, validation development template module 120 can start a cross validation process. For example, at 408, validation development template module 120 can validate that supporting fields are within a cross validation field result. A field may be marked for cross validation when one or more other fields contain information that supports the cross validation field (e.g., a narrative). The first step may be the validation of the supporting fields through the Simple Validation process above. Next, validation development template module 120 may utilize an LLM to compare the successfully validated supporting fields to the data in the cross validation fields. If all of the supporting fields are validated and contained within the cross validation field, then validation may be confirmed. Narrative fields may be made up of various component facts that are separately extracted in other fields. Validation development template module 120 can compare values from these validated fields to the associated component facts in the narrative to determine if there are any inconsistencies. Narrative values which contain one or more component field values that are inconsistent with a validated field value may be surfaced for review. At 410, validation development template module 120 can determine whether narrative fields contain all correct values from the basic fields based on the cross-validation.

The following is a specific, non-limiting example of a prompt that may be used to cause the LLM to perform cross validation. It should be understood that variations to the prompt may be possible, as long as the chosen prompt causes cross validation:
<USER>

### Explanation

{completion}

### Extraction

{extraction}

Formatting differences and variations in level of detail between the extraction and document info are acceptable.

If the extraction contains name misspellings, suffix differences, or capitalization differences, count it as correct.

Analyze the explanation above, then reply with exactly ONE word:
TRUE if the extraction is correct
FALSE if it is incorrect
</USER>

If basic field determination at 404 or cross validation at 410 fails, at 412, validation development template module 120 can flag fields not validated as correct for review. For example, values which are not validated at 402 or at 410 may be surfaced for additional review.

For example, validation development template module 120 can display validation output on the Template Development Platform along with the extractions, ground truth, scoring, and the reasoning followed by the validation LLM. A user can evaluate the validation output and make comments on each field to assist a data scientist in editing the Template for a new run. After the Template is changed, the simple validation process may be repeated until the desired performance scores are achieved. Once the desired performance scores are achieved, cross reference validation development may begin.

Similarly, validation development template module 120 can display Cross Validation output on the Template Development Platform along with the extractions, ground truth, scoring, and the reasoning followed by the validation LLM. A user can evaluate the validation output and make comments on each field to assist the data scientist in editing the Template for a new run. After the Template is changed, the Cross Reference Validation process may be repeated until the desired performance scores are achieved. Once the desired performance scores are achieved, the completed Template can be sent to template database 140. For example, at 414, validation development template module 120 can complete review of fields and update of validation template in template database 140.

FIG. 5 shows an example preprocessing process 500 according to some embodiments of the disclosure. By performing process 500, system 100 can prepare a new document for processing using an appropriate template developed by process 300 and/or 400 as described above, for example.

At 502, document preprocessing module 160 can classify a document to identify correct template(s) to use. System 100 can receive a document to be processed, for example through a pipeline between document source 10 and system 100. In some embodiments, different APIs may be provided for different document security levels, document sources 10, and/or other purposes.

To perform the document classification, document preprocessing module 160 may prompt a small language model with the document and instructions to determine its type so the correct Pre-Processing and Template can be applied. Each document type may have its own Pre-Processing settings and Template as noted above. At 504, document preprocessing module 160 can fetch best template(s) for the document from template database 140.

At 506, document preprocessing module 160 can extract text from a document, such as a PDF, or other source. For example, document preprocessing module 160 can extract text according to one or more pre-processing settings. Extraction may include extracting text using optical character recognition (OCR) and/or other known and/or novel text extraction techniques.

At 508, document preprocessing module 160 can chunk and tag document text. For example, document preprocessing module 160 can chunk and tag document text according to one or more pre-processing settings.

At 510, document preprocessing module 160 can run regex or perform other processing to identify dates and context or other target information. For example, document preprocessing module 160 can identify dates and context or other target information according to one or more pre-processing settings.

The Pre-Processing settings for extracting machine-readable text from the document, tagging and chunking that text for context retrieval purposes, and application of natural language processing to dates for the particular document type may be stored along with the Template in template database 140. Accordingly, document preprocessing module 160 can obtain these settings and apply them to the documents after Document Classification. The results of this Pre-Processing (“Pre-Processing Output”) may be ingested by extraction and validation LLMs in subsequent processing as described below with respect to FIGS. 6 and 7. For example, after Document Classification, the applicable Template may be ingested into the system along with the Pre-Processing Output. As noted above, extraction LLM may be a large LLM, and validation LLM may be a different, smaller LLM, in some embodiments.

FIG. 6 shows an example extraction process 600 according to some embodiments of the disclosure. By performing process 600, system 100 can extract data from a document by a process customized for the document type, improving extraction effectiveness, efficiency, and completeness. At this stage, the portions of the Template related to extraction may be passed through an LLM along with the Pre-Processing Output.

At 602, extraction operations module 170 can perform discrete extraction. For example, extraction operations module 170 can prompt an LLM with the template and instructions to extract structured data from the Pre-Processing Output. Discrete Extraction generally refers to the process of extracting data that can be extracted verbatim from the document (e.g., a particular date).

At 604, extraction operations module 170 can perform normalization. For fields that utilize a dictionary list, extraction operations module 170 can match the output to the list in order to normalize it to the desired form. In addition, all blank and not specified output may be normalized to “Not specified.” For fields that are normalized, formatting issues may be addressed automatically through the normalization. Extraction operations module 170 can validate structured fields for format, and invalidated formats may be automatically corrected later, as described below.

Extraction operations module 170 can determine whether extraction should be retried or is complete. If automatic evaluation passes, for example because all fields have been extracted, processing may proceed at 614 as described below. If normalization fails, at 606, extraction operations module 170 can retry. Alternatively or additionally, if normalization fails, at 608, extraction operations module 170 can add old result(s) as context for extraction retries.

For example, based on development and testing data, certain fields may be prompted again when the extracted value is ‘Not specified’. The ‘Not specified’ value may be replaced by the new extracted value. In some embodiments, a maximum of two retries are attempted (other embodiments may retry a different number of times if at all), and if ‘Not specified’ continues to be returned, then the output may remain ‘Not specified.’ For fields for data that is almost always present in the given document, the LLM may be prompted to repeat the extraction when the returned output is ‘Not specified.’ This function can also be utilized with fields that almost always return the same value (e.g., 90%+ of complaints in a particular litigation are filed in “state” court, so a repeat could be utilized when the field value is ‘federal’ court).

If the chain is incomplete, at 610, extraction operations module 170 can perform discrete extraction and/or at 612, extraction operations module 170 can perform synthesis extraction. For example, extraction operations module 170 can prompt the LLM with an extracted value and instructions to repeat extractions, and these repeats can be Discrete or Synthesized (see below). Field values can be the product of a single Discrete extraction, two Discrete extractions or a Discrete extraction followed by a Synthesized extraction, or other combinations, for example.

In discrete extraction at 610, extraction operations module 170 can prompt an LLM with the portion of the Template for a field, the output from the original Discrete extraction for that field, and the Pre-Processing Output.

In synthesized extraction at 612, extraction operations module 170 can prompt the LLM to process an initial pass on the document and use the field description to select relevant portions of the Pre-Processing Output as context for a synthesized extraction. The LLM may also be prompted to provide some explanation as to why it selected or didn't select parts of the Pre-Processing Output as context for the extraction. Extraction operations module 170 can send the selected portions of the Pre-Processing Output and explanations to the LLM in a second prompt along with the portion of the Template for that field, and the output from the original Discrete Extraction. These extractions may be performed on every available field for synthesis at once. Synthesized extractions are generally those that may require the LLM to synthesize two or more pieces of data in the document in order to provide the desired extraction output (e.g., a collection of facts in a narrative). The synthesis prompt may include the portion of the Template for that field, the output from the original Discrete extraction, and the retrieved context.

If the chain is complete, at 614, extraction operations module 170 can select a best result. In some embodiments, extraction operations module 170 can provide the LLM with the list of the extractions generated in the above processes (between one and four extractions per field), the field name, the field description, and instructions on how to select the best result from the list. These instructions can direct the LLM to pick the best answer or, when appropriate, merge multiple answers into a final answer.

If normalization succeeds at 604, or after selecting the best result at 614, at 616, extraction operations module 170 can perform formatting. For structured fields, extraction operations module 170 can prompt the LLM with a structure to populate that may contain the field name, field type, and a description that specifies the desired format. This context may be passed to the LLM along with the extracted values and a prompt instructing the LLM to correct any formatting errors. The formatted result from the LLM may be used as the final output. Unstructured fields, such as those requiring narratives, may not go through this process.

FIG. 7 shows an example validation, review, and publication process 700 according to some embodiments of the disclosure. By performing process 700, system 100 can validate, review, and publish data extracted from a document by process 600, for example. In some embodiments, all or nearly all extracted data can be validated at this stage.

At 702, extraction validation operations module 180 can validate that basic fields are correct within the document. For structured fields, extraction validation operations module 180 can prompt the LLM with a structure to populate that contains the field name, field type, and a description that specifies the desired format. This context may be passed to the LLM along with the extracted values and instructions to correct any formatting errors. As noted above, the LLM used for process 700 may be a different, smaller LLM than the LLM used for process 600. The formatted result may be used as the final output. Unstructured fields, such as those requiring narratives, do not go through this process. At 704, extraction validation operations module 180 can determine whether basic fields are correct. To perform validation of non-narrative fields, extraction validation operations module 180 may prompt a smaller LLM with the field description, Pre-Processing Output, the extracted output, and a validation rubric designed to confirm that output. Values which are not validated may be surfaced for further review as described below.

For basic fields determined to be correct, at 706, extraction validation operations module 180 can start a cross validation process. A field may be marked for cross validation when one or more other fields contain information that supports the cross validation field (e.g., a narrative). The first step may be the validation of the supporting fields through the Simple Validation process at 702.

At 708, extraction validation operations module 180 can validate that supporting fields are within a cross validation field result. For example, extraction validation operations module 180 can use an LLM to compare the successfully validated supporting fields to the data in the cross validation fields. If all of the supporting fields are validated and contained within the cross validation field, then validation may be confirmed.

At 710, extraction validation operations module 180 can determine whether narrative fields contain all correct values from the basic fields. Narrative fields are made up of various component facts that are separately extracted in other fields. Extraction validation operations module 180 can compare the values from these validated fields to the associated component facts in the narrative to determine if there are any inconsistencies. Narrative values which contain one or more component field values that are inconsistent with a validated field value may be surfaced for review.

At 712, if basic field evaluation failed at 704 or if cross validation failed at 710, review and publication module 190 can flag fields not validated as correct for review. If a component field is not validated, then Cross Reference Validation may still be performed utilizing only the component field values that were validated, but the cross validation field may be flagged for review regardless of the cross reference validation results. In situations where a component field is not validated, the reason that the cross reference validation is still performed is because it may provide the reviewer with additional information to evaluate the value for correctness.

At 714, review and publication module 190 can review and correct flagged fields. Extraction validation operations module 180 can automatically surface values that do not validate are on a platform, such as Airtable or other platforms, that enables users to efficiently review the document and unvalidated values side-by-side, correct values if necessary, and approve the values for export.

At 716, review and publication module 190 can publish extracted values. For example, extraction validation operations module 180 can export validated data to a SQL database or other data store. Data may be exported through a pipeline between the SQL database and client 20, for example.

FIG. 8 shows a computing device 800 according to some embodiments of the disclosure. For example, computing device 800 may function as system 100 and/or any portion(s) thereof, or multiple computing devices 800 may function as system 100 and/or any portion(s) thereof.

Computing device 800 may be implemented on any electronic device that runs software applications derived from compiled instructions, including without limitation personal computers, servers, smart phones, media players, electronic tablets, game consoles, email devices, etc. In some implementations, computing device 800 may include one or more processors 802, one or more input devices 804, one or more display devices 806, one or more network interfaces 808, and one or more computer-readable mediums 810. Each of these components may be coupled by bus 812, and in some embodiments, these components may be distributed among multiple physical locations and coupled by a network.

Display device 806 may be any known display technology, including but not limited to display devices using Liquid Crystal Display (LCD) or Light Emitting Diode (LED) technology. Processor(s) 802 may use any known processor technology, including but not limited to graphics processors and multi-core processors. Input device 804 may be any known input device technology, including but not limited to a keyboard (including a virtual keyboard), mouse, track ball, and touch-sensitive pad or display. Bus 812 may be any known internal or external bus technology, including but not limited to ISA, EISA, PCI, PCI Express, NuBus, USB, Serial ATA or FireWire. In some embodiments, some or all devices shown as coupled by bus 812 may not be coupled to one another by a physical bus, but by a network connection, for example. Computer-readable medium 810 may be any medium that participates in providing instructions to processor(s) 802 for execution, including without limitation, non-volatile storage media (e.g., optical disks, magnetic disks, flash drives, etc.), or volatile media (e.g., SDRAM, ROM, etc.).

Computer-readable medium 810 may include various instructions 814 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 804; sending output to display device 806; keeping track of files and directories on computer-readable medium 810; controlling peripheral devices (e.g., disk drives, printers, etc.) which can be controlled directly or through an I/O controller; and managing traffic on bus 812. Network communications instructions 816 may establish and maintain network connections (e.g., software for implementing communication protocols, such as TCP/IP, HTTP, Ethernet, telephony, etc.).

System 100 components 818 may include instructions for performing the processing described herein. For example, system 100 components 818 may provide instructions for implementing system 100 elements and/or performing processes 200-700. Application(s) 820 may be an application that uses or implements the outcome of processes described herein and/or other processes. In some embodiments, the various processes may also be implemented in operating system 814.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method comprising:
receiving, by at least one processor, data indicative of a plurality of document types;
automatically generating, by the at least one processor, a plurality of extraction templates, wherein each respective extraction template of the plurality of extraction templates corresponds to a separate respective document type of the plurality of document types;
automatically validating, by the at least one processor, each of the plurality of extraction templates, the validating comprising determining that one or more fields are correctly filled in response to performing an extraction on a document of the respective document type corresponding to the respective extraction template; and
processing, by the at least one processor, at least one document by at least one of the extraction templates.

2. The method of claim 1, wherein the generating of each respective extraction template comprises at least one of extracting text, chunking text, tagging text, and identifying regular expressions within text of at least one sample document of the separate respective document type.

3. The method of claim 1, wherein the generating of each respective extraction template comprises performing at least one discrete extraction of text from at least one sample document of the separate respective document type.

4. The method of claim 1, wherein the generating of each respective extraction template comprises performing at least one synthesis extraction of at least two combined elements from at least one sample document of the separate respective document type.

5. The method of claim 1, wherein the generating of each respective extraction template comprises formatting each respective extraction template.

6. The method of claim 1, further comprising:
determining, by the at least one processor, a change to one of the respective document types; and
repeating, by the at least one processor, the automatically generating and the automatically validating for the respective extraction template corresponding to the one of the respective document types.

7. The method of claim 1, wherein the validating of each respective extraction template comprises determining that the one or more fields are correct for the respective document type.

8. The method of claim 1, wherein the validating of each respective extraction template comprises determining that the one or more fields contain correct values for the respective document type.

9. The method of claim 1, wherein the validating of at least one respective extraction template comprises receiving at least one change to the at least one respective extraction template through a user interface.

10. The method of claim 1, wherein the validating of each respective extraction template comprises generating a respective validation template indicating correct filling of the one or more fields.

11. A method comprising:
receiving, by at least one processor, a document;
classifying, by the at least one processor, the document as having a document type of a plurality of document types;
selecting, by the at least one processor, at least one template corresponding to the document type, wherein the at least one template comprises:
at least one of a plurality of extraction templates, wherein each respective extraction template of the plurality of extraction templates corresponds to a separate respective document type of the plurality of document types; and
at least one of a plurality of validation templates, wherein each respective validation template indicates correct filling of one or more fields for the separate respective document type of the plurality of document types;
extracting, by the at least one processor, data from the document according to the at least one of the plurality of extraction templates; and
validating, by the at least one processor, the data according to the at least one of the plurality of validation templates.

12. The method of claim 11, wherein the extracting comprises at least one of extracting text, chunking text, tagging text, and identifying regular expressions within text of the document.

13. The method of claim 11, wherein the extracting comprises performing at least one discrete extraction of text from the document.

14. The method of claim 11, wherein the extracting comprises performing at least one synthesis extraction of at least two combined elements from the document.

15. The method of claim 11, wherein the extracting comprises selecting a best result from among a plurality of extraction results generated by performing a plurality of extraction attempts on the document.

16. The method of claim 11, wherein the extracting comprises formatting the data.

17. The method of claim 11, wherein the validating comprises determining that the one or more fields are correct for the document type.

18. The method of claim 11, wherein the validating comprises determining that the one or more fields contain correct values for the respective document type.

19. The method of claim 11, wherein the validating comprises receiving at least one change to the data through a user interface.

20. The method of claim 11, further comprising publishing, by the at least one processor, the data.

21. A system comprising:
at least one processor; and
at least one non-transitory computer-readable medium storing instructions that, when executed by the at least one processor, cause the at least one processor to perform processing comprising:
receiving data indicative of a plurality of document types;
automatically generating a plurality of extraction templates, wherein each respective extraction template of the plurality of extraction templates corresponds to a separate respective document type of the plurality of document types;
automatically validating each of the plurality of extraction templates, the validating comprising determining that one or more fields are correctly filled in response to performing an extraction on a document of the respective document type corresponding to the respective extraction template; and
processing at least one document by at least one of the extraction templates.

22. The system of claim 21, wherein the generating of each respective extraction template comprises at least one of extracting text, chunking text, tagging text, and identifying regular expressions within text of at least one sample document of the separate respective document type.

23. The system of claim 21, wherein the generating of each respective extraction template comprises performing at least one discrete extraction of text from at least one sample document of the separate respective document type.

24. The system of claim 21, wherein the generating of each respective extraction template comprises performing at least one synthesis extraction of at least two combined elements from at least one sample document of the separate respective document type.

25. The system of claim 21, wherein the generating of each respective extraction template comprises formatting each respective extraction template.

26. The system of claim 21, wherein the processing further comprises:
determining a change to one of the respective document types; and
repeating the automatically generating and the automatically validating for the respective extraction template corresponding to the one of the respective document types.

27. The system of claim 21, wherein the validating of each respective extraction template comprises determining that the one or more fields are correct for the respective document type.

28. The system of claim 21, wherein the validating of each respective extraction template comprises determining that the one or more fields contain correct values for the respective document type.

29. The system of claim 21, wherein the validating of at least one respective extraction template comprises receiving at least one change to the at least one respective extraction template through a user interface.

30. The system of claim 21, wherein the validating of each respective extraction template comprises generating a respective validation template indicating correct filling of the one or more fields.

31. A system comprising:
at least one processor; and
at least one non-transitory computer-readable medium storing instructions that, when executed by the at least one processor, cause the at least one processor to perform processing comprising:
receiving a document;
classifying the document as having a document type of a plurality of document types;
selecting at least one template corresponding to the document type, wherein the at least one template comprises:
at least one of a plurality of extraction templates, wherein each respective extraction template of the plurality of extraction templates corresponds to a separate respective document type of the plurality of document types; and
at least one of a plurality of validation templates, wherein each respective validation template indicates correct filling of one or more fields for the separate respective document type of the plurality of document types;
extracting data from the document according to the at least one of the plurality of extraction templates; and
validating the data according to the at least one of the plurality of validation templates.

32. The system of claim 31, wherein the extracting comprises at least one of extracting text, chunking text, tagging text, and identifying regular expressions within text of the document.

33. The system of claim 31, wherein the extracting comprises performing at least one discrete extraction of text from the document.

34. The system of claim 31, wherein the extracting comprises performing at least one synthesis extraction of at least two combined elements from the document.

35. The system of claim 31, wherein the extracting comprises selecting a best result from among a plurality of extraction results generated by performing a plurality of extraction attempts on the document.

36. The system of claim 31, wherein the extracting comprises formatting the data.

37. The system of claim 31, wherein the validating comprises determining that the one or more fields are correct for the document type.

38. The system of claim 31, wherein the validating comprises determining that the one or more fields contain correct values for the respective document type.

39. The system of claim 31, wherein the validating comprises receiving at least one change to the data through a user interface.

40. The system of claim 31, wherein the processing further comprises publishing the data.
